(19) United States
(12) Patent Application Publication
(10) Pub. No.: US 2006/0104786 A1
(43) Pub. Date: May 18, 2006

(54) Material handling vehicle

(75) Inventors: John Shepherd, Stafford (GB); Mark Lewis Whatley, Worcestershire (GB)

Correspondence Address: MACMILLAN SOBANSKI & TODD, LLC;ONE MARITIME PLAZA FOURTH FLOOR, 720 WATER STREET, TOLEDO, OH, 43604-1619, US

(73) Assignee: J. C. Bamford Excavators Limited, Staffordshire (GB)

(21) Appl. No.: 11/221,626

(22) Filed: Sep. 8, 2005

(30) Foreign Application Priority Data
Sep. 8, 2004 (GB) 0419880.0
Mar. 11, 2005 (GB) 0504972.1

(51) Int. Cl. B66C 23/00

(52) U.S. Cl. 414/699

(57) ABSTRACT

A material handling vehicle including a structure having ground engageable propulsion means and material handling apparatus mounted on the structure for movement relative thereto. The material handling apparatus has a first part and a second part. A first fluid operated actuator moves the first part relative to the structure, and a second fluid operated actuator moves the second part relative to the first part. An operator control generates a fluid pressure control signal. A first control valve supplies fluid pressure to the first actuator, a second control valve supplies fluid pressure to the second actuator in response to the fluid pressure control signal, and a modulating valve varies the fluid pressure control signal. An electronic control unit operable to control the modulating valve in accordance with a desired operation of the material handling apparatus.

### CROSS-REFERENCE TO RELATED APPLICATIONS

Priority is claimed to United Kingdom patent application Serial No. 0419880.0 filed Sep. 8, 2004, and to United Kingdom patent application Serial No. 0504972.1 filed Mar. 11, 2005.

### STATEMENT REGARDING FEDERALLY SPONSORED RESEARCH OR DEVELOPMENT

Not Applicable.

### TECHNICAL FIELD

This invention relates to a material handling vehicle.

### BACKGROUND OF THE INVENTION

In a material handling vehicle, it is known for the vehicle to be provided with a boom which carries a material handling implement. The boom is moveable relative to a structure of the vehicle by a suitable actuator, and the orientation of the material handling implement related to the boom is also operable by a suitable actuator, conventionally a fluid operated ram. Further, the boom itself may have multiple parts, where each part of the boom is moveable relative either to the vehicle or to other parts of the boom, again by suitable actuators. It is generally the case that each actuator is controlled separately by an operator by operation of an associated valve to supply fluid pressure to the actuator. In general, at least one of the actuators causes pivotal movement of the boom or a boom part relative either to the structure of the vehicle itself or to another part of the boom. Consequently, where it is required to move a material handling implement mounted on the boom along a desired path, for example in a generally straight line, or to maintain the material handling implement in a fixed orientation, for example at a constant angle to the horizontal, a great deal of skill is required on the part of an operator to provide the relative movement between the boom or boom parts, the vehicle and the material handling implement such that the material handling implement moves along the desired path.

One particular example is in backhoes. Backhoes have at least two boom parts, one of which is pivotally mounted on the vehicle structure and the other boom part which is pivotally mounted on the first boom part. In applications such as digging a trench, it is desirable to move a material handling implement in the form of a bucket provided on the boom in a straight line towards the vehicle to provide an appropriate flat bottom trench, and a great deal of operator skill is required to cause the requisite pivotal movement of the boom parts to cause the bucket to move along its desired path.

Another example is in the case of material handling vehicles which have an elongate boom mounted on the vehicle structure for pivotal movement in a vertical plane, with a material handling implement at the end of the boom, such as a pair of forks. Such booms are conventionally single part or, where the boom has multiple parts, these are telescopically moveable relative to one another. When raising or lowering the boom, it is desirable to maintain the material handling implement in a given orientation, for example to retain a load supported on the forks in a generally horizontal orientation. Again, it requires a considerable operator skill to cause the appropriate pivotal movement of the material handling implement relative to the boom during raising or lowering of the boom to maintain the desired orientation of the material handling part.

To provide for automatic movement of a material handling implement on a desired part, it is known to provide suitable electronic controllers which may be set to control the supply of fluid to the various actuators to move the material handling implement along a desired path. However, this can be disadvantageous in that total reliance on software control and sensors system may not be completely safe. It may be necessary for an operator to override the machine by sending an appropriate command, but this may not be successful depending on the nature of the failure. Further, if the electronic system fails, it is desirable to be able to control the machine in a conventional manner.

An aim of the present invention is to provide a new or improved material handling vehicle.

### BRIEF SUMMARY OF THE INVENTION

The invention is directed to a material handling vehicle including a structure having ground engageable propulsion means and material handling apparatus mounted on the structure for movement relative thereto. The material handling apparatus has a first part and a second part. A first fluid operated actuator moves the first part relative to the structure, and a second fluid operated actuator moves the second part relative to the first part. An operator control generates a fluid pressure control signal. A first control valve supplies fluid pressure to the first actuator, a second control valve supplies fluid pressure to the second actuator in response to the fluid pressure control signal, and a modulating valve varies the fluid pressure control signal. An electronic control unit operable to control the modulating valve in accordance with a desired operation of the material handling apparatus.

The second part may be a material handling implement, or a material handling implement may be mounted on the second part. The electronic control unit can control the modulating valve in order to move the material handling implement along a desired path, such as along a horizontal path, and/or to maintain an orientation of the material handling implement as it is moved along a path.

Various objects and advantages of the invention will become apparent from the following detailed description of the invention and the accompanying drawings.

### BRIEF DESCRIPTION OF THE DRAWINGS

FIG. 1 is a side elevational view of a material handling vehicle embodying the present invention;

FIG. 2 is a diagrammatic view of a hydraulic system of a material handling vehicle embodying the present invention;

FIG. 3 is a further diagrammatic illustration of the hydraulic system of a material handling vehicle embodying the present invention;

FIG. 4 is a diagrammatic illustration of a further material handling apparatus embodying the present invention;

FIG. 5 is a diagrammatic view of a hydraulic system of the material handling means of FIG. 4; and

FIG. 6 is a diagrammatic view of a further hydraulic system of the material handling means of FIG. 4.

### DETAILED DESCRIPTION OF THE INVENTION

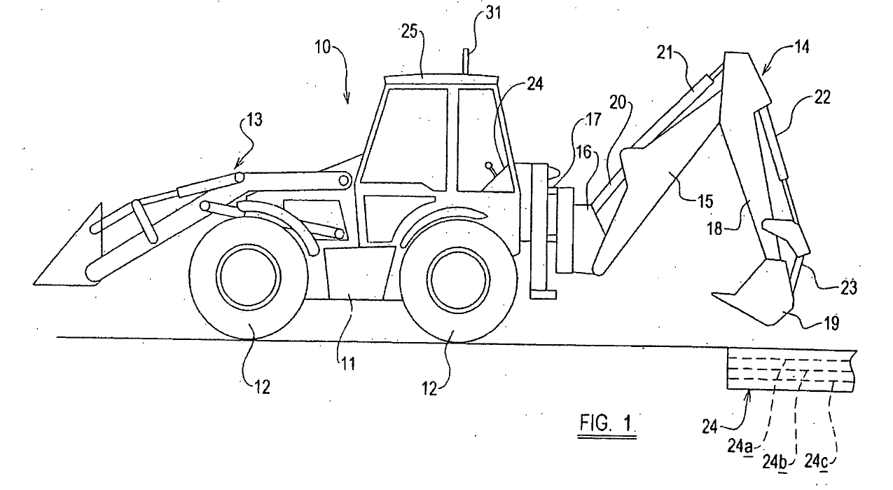

Referring now to FIG. 1, a material handling vehicle is shown at 10, in this example having a material handling apparatus, comprising a back hoe loader. The vehicle 10 comprises a structure 11 provided with ground engageable propulsion means, in this example wheels 12. The vehicle 10 is provided with a front loader 13 and a material handling means at 14. The material handling means 14 comprises a first boom part 15 pivotally mounted to the structure 11 via a king post assembly 16 of known type for pivotal movement about horizontal and vertical axes relative to the structure 11, and also for sliding sideways movement on a slide 17 in conventional manner. The back hoe 14 further comprises a second boom part 18 which is pivotally mounted on the first boom part 15. A material handling implement comprising a bucket 19 is pivotally mounted on the second boom part 18.

To provide vertical swinging movement, about a horizontal axis of the first boom part 15, a first actuator 20 comprising a fluid operated ram is mounted between the first boom part 15 and the king post assembly 16. To provide pivotal movement of the second boom part 18 relative to the first boom part 15, a second actuator 21 comprising a fluid operated ram is connected between the first boom part 15 and the second boom part 18. To provide for pivotal movement of the bucket 19 relative to the second boom part 18, a further fluid operated ram 22 is provided between the second boom part 18 and a link assembly generally shown at 23 connected to the bucket 19. The actuators 20, 21, 22 are operated from a control panel generally shown at 24 provided in an operator's cab 20 of the vehicle 10.

When it is desired to dig a trench as generally indicated at 24, conventionally the boom 14 is extended so that the bucket 19 is located away from the vehicle and is then operated to draw the bucket 19 towards the vehicle to take off a generally flat layer 24a. This process is repeated for further deeper layers 24b, 24c as required to provide a trench of 24 of appropriate depth. It will be apparent that to move the bucket along a desired path comprising a generally straight line towards the vehicle, it is necessary to operate the actuator 20 to lift the first boom part 15, that is rotate it in a generally anti-clockwise direction as shown in FIG. 1, whilst extending the actuator 21, causing the second boom part 18 to rotate relative to the first boom part 15 in a generally clockwise direction. Where the operator has individual control over the fluid supply to the actuators 20, 21, it requires operator skill to control the relative supply of fluid to the actuator to provide a flat bottom path.

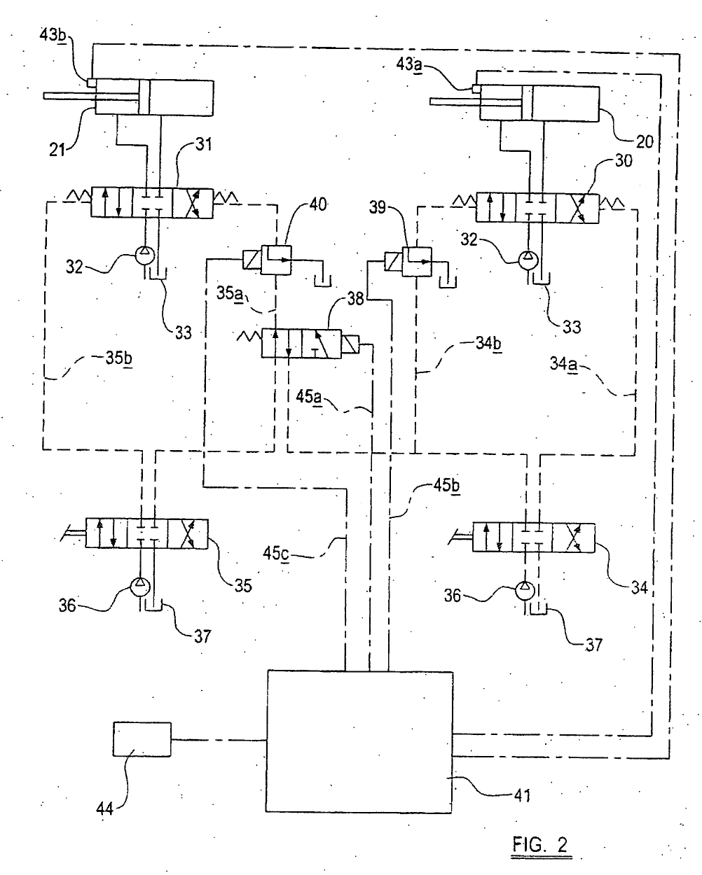

Referring now to FIG. 2, a hydraulic and electrical circuit for a material handling vehicle embodying the present invention is shown. The second actuator 21 and first actuator 20 are shown. A first control valve 30 and a second control valve 31 are shown operable to connect the first actuator 20 and second actuator 21 respectively to a source of fluid pressure as shown at 32 and to provide a return path reservoir as shown at 33 for extension or retraction as required. In this example the first control valve 30 and second control valve 31 are three-position, four-port valves operable to supply fluid pressure to either end of actuators 20, 21. The control valves 30, 31 are activated by a pilot pressure and are biased to a central neutral position as shown in FIG. 2.

To provide manual control, a first operator control 34 and a second operator control 35 are shown. The operator controls 34, 35 are operable to supply a pilot fluid pressure on lines 34a, 34b, 35a, 35b from a fluid pressure source generally illustrated at 36 and to provide a return path to reservoir as shown at 37.

A selection valve is shown at 38 comprising a two position valve. In its normal position as shown in FIG. 2, the selection valve 38 connects the control 35 on line 35a to the second control valve 31. In its second position, the valve 38 isolates the control 35 from line 35a and connects line 35a to the first control 34. Modulating valves comprising pressure reduction valves 39, 40 are provided in line 34a and line 35a respectively to connect the pilot pressure at each of the control valves 30, 31 to reservoir.

To provide for an electronic control system, an electronic controller is shown at 41. The electronic controller 41 receives a position signal on lines 42a, 42b from sensors 43a, 43b responsive to the extension of each of the actuators 20, 21. The actuator controller unit further comprises a demand signal from an operator control 44. The electronic controller 41 is further operable to control valves 38, 39, 40 on line 45a, 45b, 45c respectively to modify operation of control valves 30, 31.

The system of FIG. 2 operates as follows:

During normal operation, the valves 38, 39, 40 are in their positions as shown and so the operator can operate actuators 20, 21 in conventional manner using the controls 34, 35. Where it is desired to use the electronic controller 41 to move the material handling implement along a selected path, in the present example to create a flat bottom trench, the selector 44 is operated to pass control to the electronic controller 41. The electronic controller sends a signal on line 45a to move the valve 38 to its second position. To retract the material handling implement the operator operates the first control 34 in such a way as to supply fluid on line 34b to cause the control valve 30 to move to the right as shown in FIG. 2 to cause the actuator 20 to retract. At the same time fluid pressure is supplied via valve 38 and line 35a to cause the second control valve 31 to move to the left as shown in FIG. 2 to cause the second actuator 21 to extend. The electronic control unit receives position information on line 42a, 42b indicating the extension of the actuators 20, 21 from sensors 43a, 43b. The electronic control unit 41a then sends signals on lines 45b, 45c to operate one or both of the pressure reduction valves 39, 40 to modify or even reduce to zero the pilot pressure supplied to the control valves 30, 31 and thus modify the operation of the actuators 20, 21. The electronic control unit may, for example, calculate the position of the material handling implement 19 from the signals received from the sensors 43a, 43b, calculate a deviation from a desired path and operate the pressure reduction valves 39, 40 in order to reduce that deviation.

Once the material handling implement 19 has moved along the predetermined path, for example to excavate a layer of the trench 24, the operator may then operate the controls 34, 35 in conventional manner to return the material handling implement to the start of the trench to excavate a further layer since no modification of the fluid supplied on lines 35b and 34a is prepared. When the operator then releases control 35 and operates the control 34 to begin excavating the next layer, the system operates as described above.

Although the boom is controlled using the first control 34, it will be apparent that the hydraulic and electrical circuit could be designed such that the operator uses the second control 35 to excavate a layer of the trench.

The configuration as shown herein is advantageous in that the supply of fluid to the actuator 20, 21 is under the control of the driver such that if the control 34 moved to its central, neutral position, the actuators 20, 21 will stop moving. When the electronic control unit 41 is not operating the valves 38, 39, 40, the system functions as a conventional hydraulic system. Further, it will be apparent that it will be possible to supply all of the fluid pilot pressure from the control 34 to either the first actuator 30 or the second actuator 31, or otherwise distribute the relative pressure between the control valves 30, 31 as necessary to move the material handling implement 19 along its desired path.

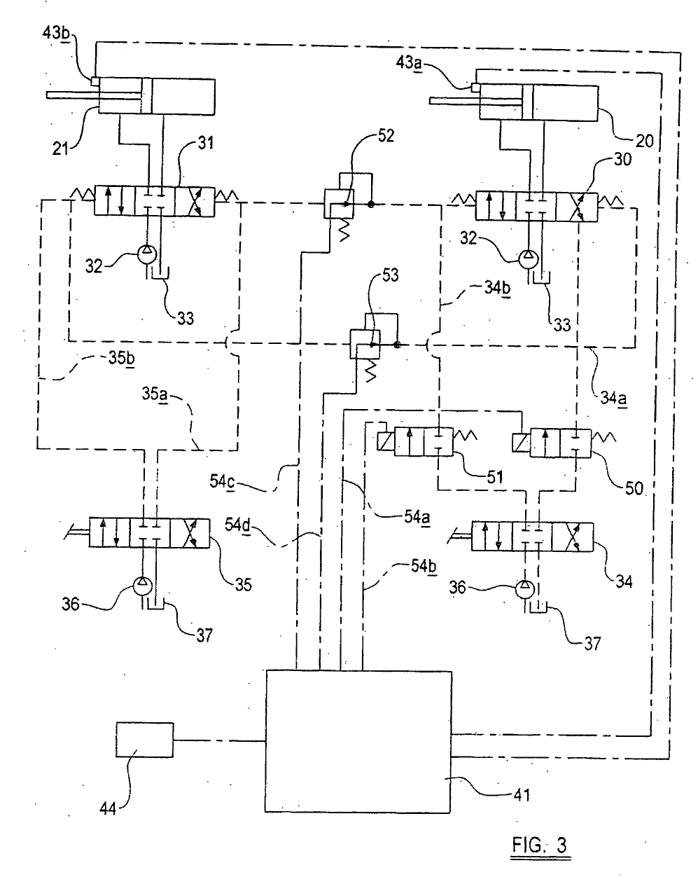

It will be apparent that, if desired, the system may be adapted to provide control of the pilot pressure to both sides of the control valves 30, 31 and thus modify the operation of the material handling device 14 in either direction. An example hydraulic and electrical circuit providing this functionality is shown in FIG. 3, where like components to the system of FIG. 2 have the same reference numerals.

The system of FIG. 3 is similar to that of FIG. 2 except that the valves 38, 39, 40 have been replaced. In this example, selection valves 50, 51 are provided operable to isolate the first control 34 from lines 34a, 34b. Modulating valves 52, 43 are provided operable to connect line 35b to line 34a and line 35a to line 34b respectively. It will be apparent that the effect of pressure reduction valves 52, 53 is to connect each side of the second control valve 31 with the opposite side of the first control valve 30. The electronic control unit 41′ is operable to control the valves 50, 51, 52, 53 by signals sent on lines 54a, 54b, 54c, 54d respectively.

In normal operation, the pressure reduction valves 52, 53 are closed and the isolation valves 50, 51 are open such that an operator can control the actuators 20, 21 using the controls 34, 35 in conventional manner. When the electronic control unit is given control, for example by actuating a demand switch 44 or otherwise, the isolation valves 50, 51 are closed to isolate the control 34 from lines 34a, 34b. The operator may then use the control 35 to move the material handling implement 19 one way or another along the predetermined path. The electronic control unit 41 will receive position signals from the sensors 43a, 43b on lines 42a, 42b and be able to calculate the position of the material handling implement 19. For example, by calculating the deviation of the material handling implement 19 from a desired path, the electronic control unit 41′ may operate one or both of the pressure reducer valves 52, 53 to modify the distribution of pilot pressure transmitted to the control valves 30, 31 and so modify the movement of the material handling implement 19.

This embodiment is advantageous in that it permits the material handling implement 19 to be moved in either direction along a predetermined path. In the particular example of digging a trench, it might be advantageous that the bucket moves in a reverse direction over the dug surface of the trench to flatten the base of the trench. It might further be envisaged that the bucket moves along a first predetermined path in a first direction and a second predetermined path in a second direction, such that the bucket, for example, performs an excavating stroke and in a returned path is lifted clear of the trench, extended to a dump position then returned to the start of the trench, whereupon the control may be operated in the opposite sense to cause the bucket to move along the first predetermined path.

It will be apparent that the system of FIG. 3 may be adapted to be operable in one direction only by, for example, omitting the valve 53 such that there is no connection between line 35b and 35a, and operating the isolating valve 50 as appropriate.

It will be apparent that the sensors 43a, 43b may be any appropriate type of sensor as required to measure the position of the actuators 20, 21, and most particularly the optical position sensors as disclosed in our granted British patent no. GB 2335980 B. Alternatively, it may be apparent that any other method of measuring the position of the material handling implement whether directly or indirectly may be used as appropriate.

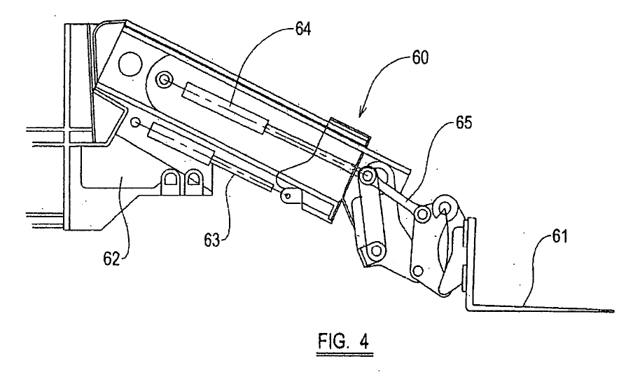

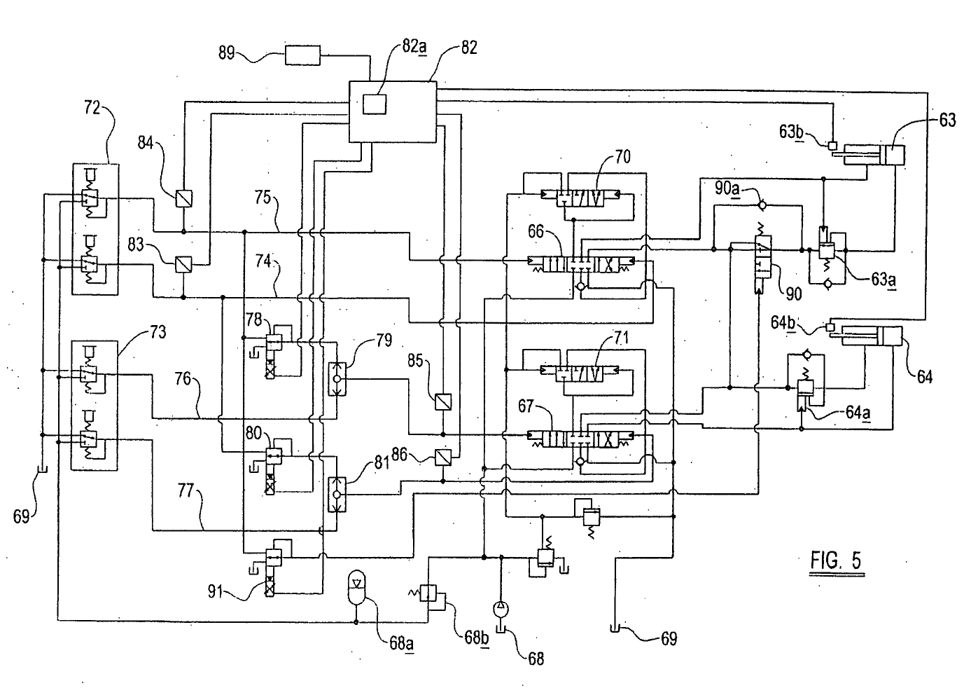

An alternative embodiment of the present invention can now be described with reference to FIGS. 4 and 5. In FIG. 4, a material handling means comprising a boom is generally shown at 60 supporting a material handling implement 61 in the form of a pair of forks. A part of the structure of a material handling vehicle on which the boom 60 is mounted is shown at 62. To provide vertical swinging movement about a horizontal axis for the boom 60, a first actuator 63 is shown connected between the structure 62 and the boom 60. To allow for pivotal movement of the material handling implement 61 relative to the boom 60, a second actuator 64 is shown mounted on the boom 60 and connected to the fork 61 via an appropriate linkage 65. Although not shown in FIG. 4, the boom 60 may be extendible telescopically via another actuator (not shown).

Referring now to FIG. 5, a hydraulic and electrical circuit for drawing the material handling implement of FIG. 4 is shown. The first actuator 63 and second actuator are shown at 63 and 64 respectively and a first control valve 66 and second control valve 67 are operable to connect the first actuator and second actuator respectively to a source of fluid pressure shown at 68 and to provide a return path to reservoir as shown at 69, to permit extension and retraction of the actuators 63, 64 as required. In this example, the first control valve 66 and the second control valve 67 are 3-position 6-port valves operable to supply fluid pressure to either end of the actuators 63, 64 respectively via a compensating circuit shown at 70, 71. The control valves 66, 67 are activated by a pilot pressure and are biased to a central, neutral position as shown in FIG. 2. To provide manual control, a first operator control 72 and a second operator control 73 are shown. The first operator control 72 provides for control of the first actuator 63 and is operable to supply a fluid pressure control signal on control line 74, to extend the first actuator 63 and raise the boom 60, or supply fluid on control line 75 to retract the actuator 63 and thus lower the boom 60. In this example, the first and second operator controls are shown as a pair of linked valves each operable to connect the respective control line to pressure source 68 or reservoir 69, but the controls may comprise single valves as shown in FIG. 1 or 2, or otherwise. The second operator control 73 is operable to supply fluid pressure line 76 to retract the actuator 64 to provide crowd movement of the forks 61, i.e. to rotate the forks in an anticlockwise direction as shown in FIG. 4. Similarly the second operator control 73 may also provide a fluid pressure control signal on line 77 to extend the actuator 64 to provide dumping movement, or clockwise rotation of the forks 61 as shown in FIG. 4.

A motion control hose burst protection valve 63a, 64a in this example is associated with each actuator 63, 64 to provide for protection in the event of a hose burst and to allow predictable load lowering. The motion control hose burst protection valves 63a, 64a may be controlled by pilot lines 63c, 64c or may alternatively be controlled by connections from control lines 75, 77.

To permit modulation of the fluid pressure control signal, the control lines 75 and 76 are connected by a proportional pressure regulator valve 78 and a selection valve comprising a shuttle valve 79. Similarly, lines 74 and 77 are connected via a proportional pressure regulator valve 80 and a selection valve comprising a shuttle valve 81.

An electronic control unit is shown at 82. The electronic control unit receives signals from pressure sensors 83, 84 connected to lines 74, 75 respectively and sensors 85, 86 which are responsive to the pressures of the outputs of the shuttle valves 79, 81 respectively. In a like manner to the previous embodiment, the electronic control unit 82 also receives position information from sensors in the form of ram extension sensors 63b, 64b responsive to the extension of the respective actuator 63, 64. The position information provides the portion of the lift/lower function and the crowd/tilt functions to the ECU. As discussed herein, any appropriate type of sensor as desired may be used to measure the extension of the actuators 63 and 64 such as the optical position sensors disclosed in our granted British patent number GB 2335980 B.

To provide for safe lowering of the boom 60 and material handling implement 61 in the event of loss of fluid pressure from the source 68, the circuit further includes an emergency valve 90 connected between the piston end of the actuator 63 and the annular end of the actuator 64. The valve is connected to line 75 via proportional pressure regulator valve 91, the proportional pressure regulator valve 91 being controlled via the electronic control unit 82. When pressure is supplied to the emergency valve 90, the actuator 63 is connected to first control valve 66 in conventional manner, and when no pressure is supplied from line 75 to the valve 90, the valve returns to the position shown in which the piston end of the actuator 63 is connected to the annular end of the actuator 64. Fluid pressure is stored in an accumulator 68a via a pilot supply valve 68b, which also supplies fluid pressure to the operator controls 72, 73.

When the operator wishes to operate the boom 60 and material handling implement 61 in conventional manner, he can control the extension of the actuators 63, 64 using the first and second operator controls 72, 73. Thus, to lower the boom, the first operator control is operated to supply fluid on line 75 to the first control valve 66, urging it to the right as viewed in FIG. 5 such that the annular end of actuator 63 is connected to source 68. Valve 90 is moved to connect the piston end of the actuator 63 to the first control valve 66 and then to reservoir 69. Similarly, when it is desired to raise the boom 60, the first operator control 72 is operated to supply fluid pressure control signal on line 74 to urge the first control valve 66 to its left most position thus connecting the piston end of the actuator 63 to reservoir 68 via bypass valve 90a, bypassing the emergency valve 90, and the annular end of the actuator 63 is connected to the reservoir to lower the boom 60. The output power supplied to the actuator 63 us proportioned to the pilot signal from the first control valve 66. Operation of the second control valve 73 to crowd or dump the material handling implement 61 is proceeds in a similar manner, and the supplied fluid pressure control signal from the second control valve 73 passes through the shuttle valve 79, 81 to second control valve 67, as there is no competing pressure on the shuttle valve 79, 81.

When the electronic controller 82 is required to provide a desired operation, in this case to maintain in the material handling implement 61 in its desired orientation, controller 89 is operated to case the electronic controller 82 to operate. When the first operator control 72 is then operated to supply a fluid pressure control signal on one of lines 74, 75 this pressure is detected by respective pressure sensor 83, 84 and a pressure valve signal is supplied to the electronic control unit 82. When the boom is being raised, i.e., a fluid pressure control signal is being supplied on line 74, to maintain the orientation of the material handling implement 61 it is necessary to perform a dumping movement, i.e. rotate the material handling implement 61 in a clockwise direction relative to the boom 60 as shown in FIG. 4. The electronic control unit 82 is hence operable to control the proportional pressure regulated valve 78 to supply a proportion of the fluid pressure control signal from the first operator control 72 to the second control valve 67 via the selection valve in the form of shuttle valve 81. Similarly, when it is desired to lower the boom, pressure is supplied on line 75 which is detected by sensor 84 and the electronic control unit 82 is operable to control the proportional pressure regulator valve 78 to supply pressure from line 75 via the shuttle valve 81 to the second control valve 79 to retract the actuator 64 to provide crowding movement of the material handling implement 61.

In a simple implementation, the extension values received from the ram extension sensors 63b, 64b are used by the ECU to select the appropriate ratio of the fluid pressure control signal sent to each of the control valves 66, 67 using a look up table. The proportional pressure regulator valve 78, 80 are controlled by the ECU accordingly to provide the ratio between the fluid pressure control signals. The position information received from the ram extension sensors 63b, 64b are updated approximately every 10 milliseconds and the ECU controls the valve 78,80. In the event of failure of the sensors 63b, 64b, the ECU generates the pressure control signal in a ratio according to a pre-programmed nominal set of values dependent on the particular geometry of the boom 60 and material handling implement 61.

It will be apparent that during this operation, if it is desired to change the orientation of the material handling from 61, the second operator control 73 may be operated to supply a fluid pressure control signal which, if it is greater than the proportion of the fluid pressure control signal from the first operator control supplied by valve 78 or 80, will override that signal at the shuttle valve 79, 81 and thus supply a fluid pressure control signal to the second control valve 67 to provide the appropriate extension or retraction of the actuator 64. When the fluid pressure control signal from the second operator controls 73 ceases, the supply of fluid pressure control signals via the valve 78, 80 and shuttle valve 79, 81 to the second control valve 67 will resume as before but will act to maintain the material handling implement 61 in its new orientation.

Once again, the electronic control unit 82 only has partial control over the system, such that if the operator releases the first operator control 72 such that it is in a neutral position, no fluid pressure control signal will be generated and, the first control valve 66 will return to the central position and no fluid will be supplied to actuator 63. Similarly, providing the second operator control 73 is in a neutral position, no fluid pressure control signal will be supplied from either of the first operator control 72 or second operator control 73 to the second control valve 67 and hence no fluid pressure will be supplied to the second actuator 64. Automatic operation under the control of the electronic control unit 82 may thus be halted simply by releasing the operator control, as in the first embodiment of the invention.

In the event of loss of fluid pressure in the system, from source 68, then the system will be operable as follows. During normal operation, the accumulator 68a will be pressurized from fluid pressure source 68 via the pilot supply valve 68b. In the event of loss of pressure, the accumulator 68a will provide sufficient pressure for the first operator control valve 72 to supply to appropriate pilot pressure to the first control valve 66 and the second operator control valve 73 to supply a fluid pressure control signal to the second control valve 67. Under the force of gravity, the weight of the boom 60 will act to force fluid from the piston end of the actuator 63 which passes, via the emergency valve 90 to the annular end of the second actuator 64 to provide for crowding movement of the material handling implement 61. By operating the operator controls 72, 73 the fluid can be allowed to pass from the piston end of the actuator 64, to the reservoir, allowing the boom 60 to descend and the material handling implement 61 to crowd in a controlled manner so that the boom 60 can be lowered to a safe position without dislodging a load from the material handling implement 61.

In the embodiment of FIG. 5, the electronic control unit 82 detects operation of the first operator control 72 through the use of pressure sensors 83, 84, although any other method of detection, such as electronically sensing the position of the first operator control 72, may be used as desired.

The electronic control unit may use an appropriate control algorithm to select the proportion of pressure to be supplied to the second control valve 67. In a simple example, the electronic control unit 82 may store a look up table illustrated at 82a which holds the boom angles 60 as indicated by the degree of extension of the actuator 63 and a corresponding desired relative angle of the material handling implement 61, as set by actuator 64 and detected by sensor 64b. The electronic control unit 82 may detect the boom angle from the extension of the actuator 63, measure the angle of the material handling implement 61, compare the measured angle of the material handling implement 61 with the desired value in the look up table 82a and operate the proportional pressure regulator valves 78, 80 to adjust the measured angle of the material handling implement 61 towards a desired value. The desired angle of the material handling implement 61 may be a relative rather than an absolute value, to permit the orientation of the material handling implement 61 to be varied by the operator as desired and then for the electronic control unit 82 to maintain that orientation during movement of the boom 60.

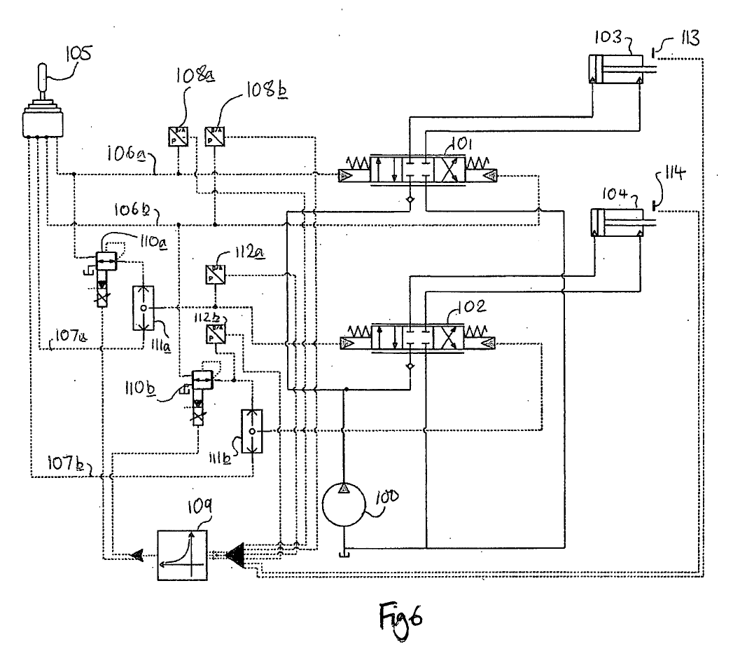

With reference to FIG. 6, a further hydraulic system for use with the material handling means for FIG. 4 is illustrated. A fluid source comprising on this example a pump 100 is operable to supply fluid under pressure to first and second control valves 101, 102 which are controllable to supply fluid under pressure to a raise/lower actuator comprising a hydraulic ram 103, and a crowd/tip actuator comprising a hydraulic ram 104. A single operator controllable joy stick 105 is shown which is operable to supply fluid pressure control signals on lines 106a and 106b respective to the first control valve 101, and on lines 107a, 107b to the second control valve 102. Pressure sensors 108a, 108b are responsive to the pressure in lines 106a and 106b respectively, and operable to send signals indicating the pressure in line to electronic control unit 109. The joy stick 105 thus acts as both first operator control and second operator control.

To permit the ratio of the fluid pressure control signal sent to first actuator 101 and second actuator 102 to be varied by the electronic control unit 109, proportional pressure control valve 110a is connected to line 106a, and proportional pressure control valve 110b is connected to line 106b. Lines 107a and valve 110a are connected to a first shuttle valve 111a which is connected to the second actuator 102 to provide control of the tip function, whilst line 107b and proportional pressure control valve 110b are connected to shuttle valve 111b which is connected to the second actuator 102 to provide control of the crowd function. Pressure transducers 112a and 112b are responsive to the pressure output from the shuttle valve 111a and the second proportional pressure control valve 110 and send a proportional signal to the ECU 109.

In a similar manner to the proceeding embodiments, the joy stick 105 is operated to raise or lower the boom by sending an appropriate fluid pressure control signal on line 106a or 106b respectively. The pressure supplied from the fluid pressure source 100 to the actuator 103 by the first control valve 101 is proportional to the pressure supplied on lines 106a or 106b. The pressure is detected to the respective pressure sensors 108a, 108b and the value is sent to the electronic control unit. When it is desired to maintain the boom 60 and material handling implement 61 in a given orientation, the electronic control unit 109 is operable to control the respective proportional pressure of the control valve 110a, 110b to supply a proportion of the pressure on line 106a, 106b respectively to the second control valve 102 to provide tipping or crowding operation respectively to obtain the appropriate orientation of the material handling implement 61. The ratio of the fluid pressure control signal supplied to the first and second control valves 101, 102 is selected by the electronic control unit 109 from a look up table in accordance with the extension of the respective actuator 103, 104. The position information from the ram extension sensors 113, 114 is transmitted to the ECU 109 every 10 milliseconds or so and the signals to the proportional valves selected accordingly. Should the ram extension sensors 113, 114 fail, the electronic control unit can use a pre-programmed nominal value for the ratio dependent on the nominal geometry of the boom 60 and material handling implement 61.

In all of the embodiments of the invention described herein, it will be apparent that if the electronic control unit 41, 82 fails, the hydraulic systems of the material handling vehicle may be operated in a conventional manner. Similarly, if the material handling vehicle is operating under the control of the electronic control unit 41, 82 and the operator wishes to cease the operation of the material handling vehicle whether in an emergency or otherwise, the operator merely has to release the operator control 34, 35, 72, 73 and the supply of fluid to the actuators will be stopped.

Although the present examples shown herein particularly refers to a back hoe loader having a material handling means comprising a two-part boom or a simple component or telescopic boom for a telehandler, it will be apparent that the system may be adapted for any other appropriate type of material handling means, such as one provided with a three-part boom, or with a pivotal and extendible boom, or otherwise as desired. Similarly, although the present example shows a material handling implement comprising a bucket, it will be apparent that the material handling implement may be any other implement as desired, such as forks. The material handling vehicle may be any appropriate type of vehicle such as a telehandler, loading shovel, back hoe mini excavator or otherwise, and may be tracked/or wheeled, provided with conventional or skid steering and have any appropriate configuration as desired.

Similarly, while the desired operations described herein comprise moving a backhoe bucket in a straight path and maintaining the forks of a telehandler in a desired orientation, it will be apparent that the desired operation may comprise any desired operation of any complexity. For example, it might be envisaged that the electronic controller is operable to control the material handling implement to perform a complete dig cycle, or to control a telehandler boom to move a set of forks along a straight horizontal path, or to limit extension of a boom past a point of instability, or indeed any other type of operation.

In the present specification “comprises” means “includes or consists of” and “comprising” means “including or consisting of”.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilized for realizing the invention in diverse forms thereof.

It will be appreciated that various modifications and changes may be made to the above described preferred embodiment of without departing from the scope of the following claims.

1. A material handling vehicle comprising a structure having ground engageable propulsion means; material handling apparatus mounted on the structure for movement relative thereto including a first part and a second part; a first fluid operated actuator operable to move the first part relative to the structure and a second fluid operated actuator operable to move the second part relative to the first part; an operator control operable to generate a fluid pressure control signal; a first control valve operable to supply fluid pressure to said first actuator in response to said fluid pressure control signal and a second control valve operable to supply fluid pressure to said second actuator in response to said fluid pressure control signal; a modulating valve operable to vary said fluid pressure control signal; an electronic control unit operable to control said modulating valve in accordance with a desired operation of the material handling apparatus, and wherein a fluid pressure control signal must be generated to permit operation of said first actuator and said second actuator.

2. A material handling vehicle according to claim 1 wherein, when the operator control is in a neutral position, no fluid pressure control signal is generated.

3. A material handling vehicle according to claim 2 wherein, when no fluid pressure control signal is generated, said first control valve and said second control valve are in a closed condition such that no fluid pressure is supplied to said first actuator or said second actuator.

4. A material handling vehicle according to claim 1 wherein said operator control comprises a first operator control operable to supply a fluid pressure control signal to said first control valve and where said modulating valve is controllable by said electronic control unit to modify the supply of said fluid pressure control signal to said first control valve and said second control valve.

5. A material handing vehicle according to claim 4 wherein the operator control further includes a second control operable to generate a fluid pressure control signal which is supplied to said second control valve.

6. A material handling vehicle according to claim 5 and further including a selection valve, and wherein said fluid pressure control signal from one of said first operator control and said second operator control is supplied through said selection valve to said second control valve.

7. A material handling vehicle according to claim 6 wherein said selection valve comprises a blocking valve adapted to prevent the supply of a fluid pressure control signal from said second operator control to said second control valve.

8. A material handling vehicle according to claim 4 wherein said modulating valve is operable to supply a proportion of said fluid pressure control signal from said first operator control to said second control valve.

9. A material handling vehicle according to claim 1 and further including a material handling implement and a position sensing element operable to generate a position signal indicating the position of said material handling implement, and wherein said electronic control unit is operable to receive said position signal and to modify operation of said first actuator and said second actuator to move said material handling implement along a selected path.

10. A material handling vehicle according to claim 9 wherein said position sensing element includes a first sensor responsive to extension of said first actuator and a second sensor responsive to extension of said second actuator, and wherein said electronic control unit is operable to calculate the position of said material handling implement from a position signal indicating the extension of said first actuator and said second actuator.

11. A material handling vehicle according to claim 1 wherein said first part includes a first boom part, wherein said second part includes a second boom part pivotally moveable relative to said first boom part, wherein said material handling vehicle includes a material handling implement supported on said second boom part, and wherein said electronic control unit causes said material handling implement to move along a selected path.

12. A material handling vehicle according to claim 11 wherein said selected path comprises a generally horizontal straight path in a direction towards said structure.

13. A material handling vehicle according to claim 1 wherein said first part includes a boom and said second part includes a material handling implement, and wherein said electronic control unit maintains said material handling implement in a desired orientation as it is moved.

14. A material handling vehicle according to claim 1 and including a material handling implement comprises one of a bucket, and a fork.
